(19) United States
(12) Patent Application Publication
(10) Pub. No.: US 2024/0357727 A1
(43) Pub. Date: Oct. 24, 2024

(54) METHOD AND APPARATUS FOR REAL TIME OPTIMIZATION OF A MICROWAVE PLASMA

(71) Applicant: 6K Inc., North Andover, MA (US)

(72) Inventors: Michael KOZLOWSKI, Reading, MA (US); Zongren SHANG, Westborough, MA (US)

(73) Assignee: 6K Inc., North Andover, MA (US)

(21) Appl. No.: 18/687,239

(22) PCT Filed: Aug. 17, 2022
(86) PCT No.: PCT/US22/75081

§ 371 Date: Feb. 27, 2024

Related U.S. Application Data
(60) Provisional application No. 63/238,339, filed on Aug. 30, 2021.

(51) Int. Cl. H05H 1/30; B23K 10/00; H05B 6/68

(52) U.S. Cl. CPC H05H 1/30; B23K 10/006; H05B 6/68

(57) ABSTRACT

A method of real time optimization of a microwave plasma includes adjusting in real time an injection angle of a swirl gas flow of the microwave plasma, the magnitude of the swirl gas flow of the microwave plasma, or the microwave power applied to the microwave plasma.

### CROSS REFERENCE TO RELATED APPLICATIONS

This application claims the benefit of and priority to U.S. Provisional Patent Application Ser. No. 63/238,339, entitled “Method and Apparatus for Real Time Optimization of a Microwave Plasma” filed on Aug. 30, 2021. The content of U.S. Ser. No. 63/238,339 is hereby incorporated by reference in its entirety.

### FIELD OF THE TECHNOLOGY

The present technology generally relates to devices, systems, and methods for optimization of a microwave plasma in real time. In particular, the present technology relates to methods and systems for adjusting in real time the injection angle of a swirl gas flow of a microwave plasma or the reflected microwave power applied to a microwave plasma.

### BACKGROUND

Plasma torches provide a high temperature plasma for a variety of purposes. In general, there are several types of plasma torches including induction plasma torches and microwave plasma torches. Other types of plasma torches can include direct current (DC) plasma, with arcing between a cathode and anode. These high temperature plasmas may enable processing of a variety of materials that are exposed to or fed into the plasma. A number of non-trivial challenges arise when attempting to adjust the conditions and temperature profiles created by such plasmas.

### SUMMARY

Provided herein are devices and methods for optimizing a microwave plasma in real time. According to one aspect of the present disclosure, a method of real time optimization of a microwave plasma is disclosed. The method includes adjusting in real time an injection angle of a swirl gas flow of the microwave plasma, or optimizing a reflected microwave power measured from the microwave plasma. In some embodiments, the method also includes generating a microwave plasma utilizing a core gas flow and the swirl gas flow; adjusting the injection angle of the swirl gas flow by adjusting at least one movable gas jet nozzle; and optimizing the reflected microwave power measured from the microwave plasma using an adjustable waveguide tuner with a plurality of tuner positions, or an adjustable waveguide sliding short. In some embodiments, the method also includes positioning a thermocouple at a location of interest with respect to the microwave plasma; evaluating a temperature profile of the microwave plasma; and adjusting the injection angle of the swirl gas by adjusting a movable gas jet nozzle in order to achieve a desired temperature profile in real time. In some embodiments, the method also includes positioning a thermocouple at a location of interest with respect to the microwave plasma; evaluating a temperature profile of the microwave plasma; and optimizing reflected microwave power measured from the microwave plasma using an adjustable waveguide tuner with a number of tuner positions, or an adjustable waveguide sliding short to achieve a desired temperature profile in real time. In some embodiments, the movable gas jet nozzle includes a pivot joint protrusion extending from a portion of the nozzle to secure the nozzle within a bore of a cylindrical housing and allow the nozzle to swivel within the bore at different angles. In some embodiments, adjusting the movable gas jet nozzle includes moving an adjusting ring that is in contact with the nozzle to adjust an angle of orientation of the nozzle. In some embodiments, the method also includes raising a magnitude of the swirl gas flow to increase mixing within the microwave plasma and homogenize a temperature profile within the microwave plasma; or reducing a magnitude of the swirl gas flow to straighten the core gas flow.

According to another aspect of the present disclosure, a real time plasma optimization system is disclosed. The system includes a plasma torch housing having at least one core gas flow port and at least one movable swirl gas flow port; an adjustable waveguide tuner having a number of tuner positions; and an adjustable waveguide sliding short. In some embodiments, the adjustable waveguide tuner and the adjustable waveguide sliding short control a reflected microwave power measured from a microwave plasma in real time. In some embodiments, the movable swirl gas flow port adjusts the injection angle of a swirl gas. In some embodiments, the movable gas jet nozzle includes a pivot joint protrusion extending from a portion of the movable gas jet nozzle to secure the nozzle within a bore of the plasma torch housing and allow the nozzle to swivel within the bore at different angles. In some embodiments, the system also includes an adjusting ring in contact with the movable gas jet nozzle to adjust an angle of orientation of the movable gas jet nozzle. In some embodiments, the plasma torch housing defines a number of bores disposed around an inlet of a plasma torch liner, and each of the bores includes one movable gas jet nozzle.

According to another aspect of the present disclosure, an adjustable gas inlet device is disclosed. The device includes a cylindrical housing with an outer surface and an inner surface. The outer surface has a greater circumference than the inner surface, and the cylindrical housing defining at least one bore passing from the outer surface to the inner surface through the cylindrical housing. The adjustable gas inlet device also includes a movable gas jet nozzle disposed within the bore. The movable gas jet nozzle includes a gas inlet port near the outer surface of the cylindrical housing and a gas outlet port near the inner surface of the cylindrical housing and provides fluid communication from outside the outer surface to within the inner surface. The adjustable gas inlet device also includes a pivot joint protrusion extending from a portion of the movable gas jet nozzle and in contact with the cylindrical housing within the bore to secure the movable gas jet nozzle within the bore and allow the movable gas jet nozzle to swivel within the bore at different angles. In some embodiments, the cylindrical housing defines a number of bores disposed around the cylindrical housing. In some embodiments, the cylindrical housing also defines an annular groove within the outer surface. In some embodiments, the bore passing from the outer surface to the inner surface through the cylindrical housing is oriented at an angle with respect to a radial line extending from a center of the cylindrical housing to the outer surface. In some embodiments, the pivot joint protrusion has a rounded shape and fits within a socket within the bore. In some embodiments, the device also includes an adjusting ring in contact with the movable gas jet nozzle to adjust an angle of orientation of the movable gas jet nozzle. In some embodiments, the cylindrical housing is positioned within a plasma torch housing and provides an angular gas flow through the movable gas jet nozzle to a plasma chamber.

### BRIEF DESCRIPTION OF THE DRAWINGS

The invention may be more fully understood from the following detailed description taken in conjunction with the accompanying drawings.

FIG. 1 is a cross sectional view of an example microwave plasma torch with an adjustable sliding short and tuner, according to one embodiment of the present disclosure.

FIG. 2 is an exploded view of an adjustable gas inlet device, according to one embodiment of the present disclosure.

FIG. 3 is a selective side view of the adjustable gas inlet device of FIG. 2, according to one embodiment of the present disclosure.

FIG. 4 is a cross sectional plan view of the adjustable gas inlet device of FIG. 2, according to one embodiment of the present disclosure.

FIG. 5 is a flow chart illustrating a method of optimizing a microwave plasma in real time, according to one embodiment of the present disclosure.

### DETAILED DESCRIPTION

Certain exemplary embodiments will now be described to provide an overall understanding of the principles of the structure, function, manufacture, and use of the devices and methods disclosed herein. One or more examples of these embodiments are illustrated in the accompanying drawings. Those skilled in the art will understand that the devices and methods specifically described herein and illustrated in the accompanying drawings are non-limiting exemplary embodiments and that the scope of the present invention is defined solely by the claims. The features illustrated or described in connection with one exemplary embodiment may be combined with the features of other embodiments. Such modifications and variations are intended to be included within the scope of the present technology.

The embodiments disclosed herein can provide one or more of the following advantages. In some embodiments, various parameters of a microwave plasma can be adjusted in real time. The techniques disclosed herein allow for the adjustment and customization of the inlet angle of a swirl flow in real time. This allows for customization of the temperature profile within a plasma in real time without the need to extinguish and re-ignite the plasma between each adjustment.

In some embodiments, an optimization scheme can be created for a particular process requirement or to address time-varying drift in a system. For example, as the output temperature of the torch drifts as the system reaches steady-state operation, the tuning algorithm can adjust the inputs in order to regain the desired output temperature. In another example, the magnitude of the swirl can be raised to increase mixing and homogenize the temperature output profile, or reduced to achieve a straighter process gas flow. Various inputs can be modified to achieve a specific output power, temperature, and/or velocity at a point location or over a defined volume.

An example technique for tuning a microwave plasma can include adjusting input parameters to achieve a homogenous temperature profile below the torch exit above a prescribed temperature. Such a method can include installing a thermocouple array in a location of interest. Starting with a first power set point, the method can sweep through various torch gas flows and injection angles to evaluate the temperature profile. For the setting that maximizes uniformity, does the average temperature reach the desired temperature? If yes, the reflected power can be optimized using tuning stubs and a sliding short. If not, power can be increased.

In some embodiments, automating the process a full variable space can be evaluated in real time without hardware changes or manual intervention. The techniques disclosed herein can be applied to find an optimal steady-state run condition, or to bring a drifting process back into range.

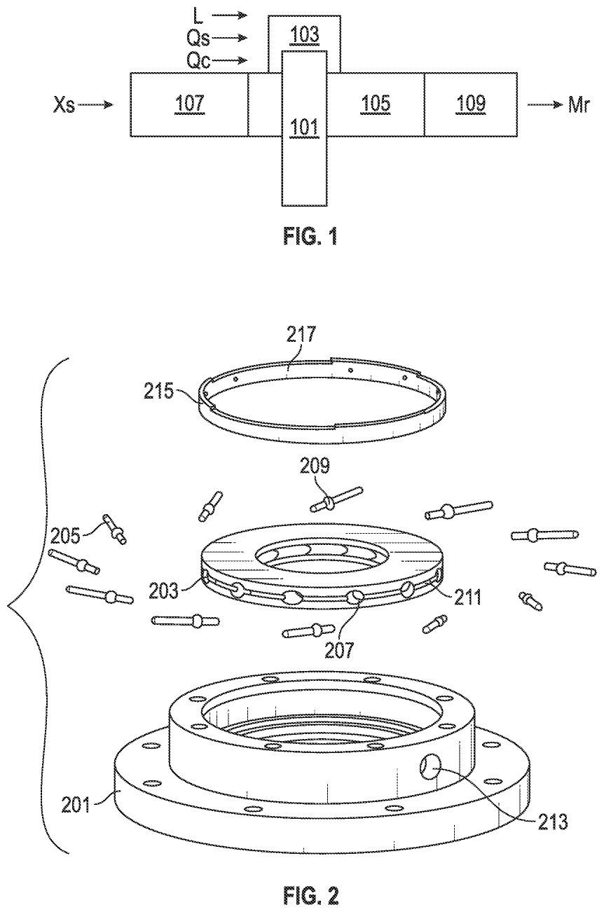

FIG. 1 is a cross sectional view of an example microwave plasma torch with an adjustable sliding short 107 and tuner 109, according to one embodiment of the present disclosure. In this embodiment, the adjustable plasma system includes a torch housing 103, torch liner 101, applicator 105, adjustable sliding short 107, and tuner 109. The torch housing 103 can be secured to or around a portion of the torch liner 101 in order to provide a core gas flow Qc and a swirl gas flow Qs within the torch liner 101 via the torch housing 103. In some embodiments, the core gas flow Qc and the swirl gas flow Qs combine to create a swirling pattern with a given amount of angular momentum L, in order to stabilize and sustain the plasma within the plasma liner 101, or within a portion of the liner. According to some embodiments, the injection angle of the swirl gas flow Qs can be adjusted using one or more movable gas jet nozzles. In addition to flow adjustment, plasma stability and process efficiency can be optimized by adjusting the position Xs of the sliding short 107, and/or the positions of the tuner 109. In some embodiments, the tuner 109 can be set to any one of a number of tuner stub positions S₁, S₂ . . . Sₙ. Real time adjustments made to the sliding short 107 or the tuner 109 can optimize the reflected microwave power Mr in real time.

In some embodiments, a feed material can be fed into the plasma torch and placed into contact with the microwave generated plasma. Different feed materials or processing methods may require different processing times or temperature profiles, and the techniques described herein can allow for real time adjustment of the temperature profile within the plasma and real time adjustment of the microwave power applied to the plasma.

In some embodiments, some elements of the microwave generated plasma and torch may be similar to those described in U.S. Pat. No. 10,477,665, and/or U.S. Pat. No. 8,748,785, each of which is hereby incorporated by reference in its entirety.

FIG. 2 is an exploded view of an adjustable gas inlet device, according to one embodiment of the present disclosure. In this embodiment, a number of movable gas jet nozzles 205 are disposed within bores 207 formed within a cylindrical housing 203. In some embodiments, the cylindrical housing has an outer surface with a greater circumference than its inner surface, and each bore 207 can pass through the cylindrical housing from the outer surface to the inner surface.

In an embodiment, each movable gas jet nozzle 205 can be positioned within a bore 207 of the cylindrical housing 203 and can have a substantially tubular shape. The movable gas jet nozzles can include a gas inlet port near the outer surface of the cylindrical housing and a gas outlet port near the inner surface of the cylindrical housing in order to provide fluid from the outside to the inside of the cylindrical housing. When positioned within a torch housing 201, the inlet port of at least one of the movable gas jet nozzles 205 can align with a gas inlet 213 of the torch housing 201.

In this embodiment, the movable gas jet nozzles 205 can also include a pivot joint 209 that extends from a portion of the nozzle. This pivot joint 209 can be in contact with the cylindrical housing 203 within the bore 207 in order to secure the movable gas jet nozzle 205 within the bore 207 and allow it to swivel within the bore 207 at different angles. In some embodiments, the pivot joint 209 includes a rounded shape and the bore 207 includes a mechanical feature, such as a ridge or socket, to mate with the pivot joint 209 of the movable gas jet nozzle 205. There may be sufficient space within each bore 207 in order to allow the movable gas jet nozzles 205 to pivot or swivel within the bore 207 in a large range of angles in three dimensions. In some embodiments, the movable gas jet nozzles 205 can swivel vertically forming various angles with respect to the central axis of the cylindrical housing 203. In some embodiments, the movable gas jet nozzles 205 can also swivel horizontally forming various angles with respect to a radius of the cylindrical housing 203.

In an embodiment, an adjusting ring 215 can be used to adjust the position or angle of the movable gas jet nozzles 205. The adjustable ring 215 can fit at least partially around the cylindrical housing 203 and can rotate separately from the cylindrical housing 203. In some embodiments, the adjusting ring 215 can include one or more points of contact 217, such as protrusions or openings in the adjusting ring 215, that can contact a portion of the movable gas jet nozzles 205. By rotating or moving the adjusting ring 215, the movable gas jet nozzles 205 can swivel or pivot within the bores 207 and alter the angle of entry of any gas flowing through the nozzles.

In some embodiments, the cylindrical housing 203 can include a number of bores 207 that are disposed symmetrically around the cylindrical housing 203. The cylindrical housing 203 can also include an annular groove 211 within its outer surface. In some embodiments, the annular groove 211 can connect the bores 207 to each other. In some embodiments, the techniques described herein allow for real time adjustment of the angle of attack of the swirl injection in order to independently vary the angular momentum (i.e. the amount of swirl) and total torch gas flow. In some embodiments, the angular momentum can be varied in real time while the plasma is running, thus adding an additional in-situ process variable.

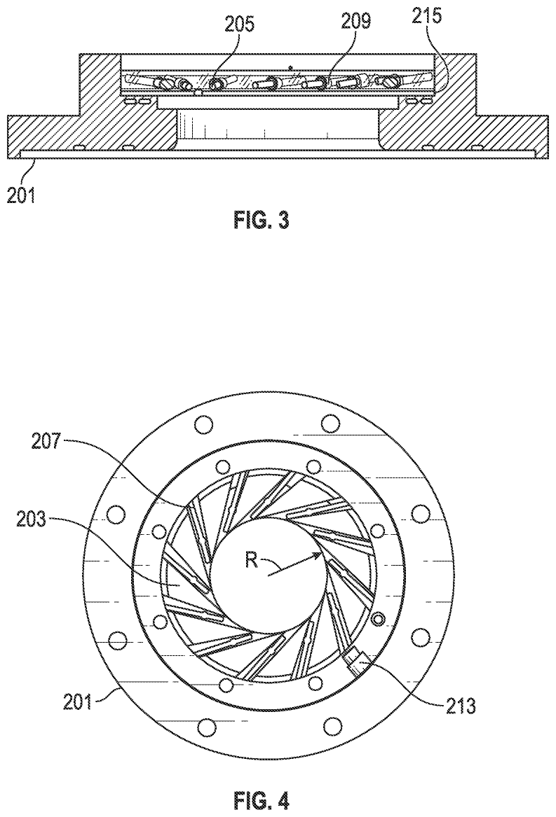

FIG. 3 is a selective side view of the adjustable gas inlet device of FIG. 2, according to one embodiment of the present disclosure. In this embodiment, the movable gas jet nozzles 205 within the cylindrical housing are visible within a partially transparent view of the torch housing 201. The pivot joints 209 can also be seen on the movable gas jet nozzles 205, and the outline of the adjusting ring 215 is also shown around the cylindrical housing. In this particular embodiment, the adjusting ring 215 and cylindrical housing are each sized and shaped to fit within the torch housing 201.

FIG. 4 is a cross sectional plan view of the adjustable gas inlet device of FIG. 2, according to one embodiment of the present disclosure. In this embodiment, the cylindrical housing 203 can be seen positioned within the torch housing 201. The cylindrical housing includes a number of bores 207, within which are located the movable gas jet nozzles, as discussed above. Each of the bores 207 passes through the cylindrical housing 203 and is oriented at an angle with respect to a radial line R extending from the center of the cylindrical housing 203, in this embodiment.

In the embodiment shown in FIG. 4, the torch housing 201 also includes a gas inlet 213 that can align with at least one of the bores 207 in the cylindrical housing 203 in order to provide a gas flow through at least one of the movable gas jet nozzles to a plasma chamber.

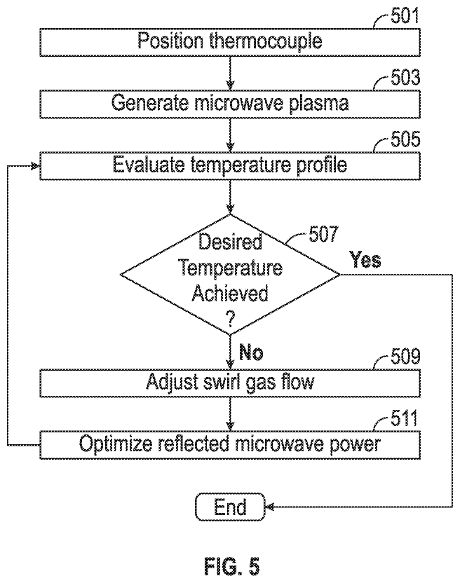

FIG. 5 is a flow chart illustrating a method of optimizing a microwave plasma in real time, according to one embodiment of the present disclosure. In operation 501, one or more thermocouples, or a thermocouple array, is positioned at a location of interest with respect to the microwave plasma.

At operation 503, a microwave plasma is generated utilizing a core gas flow and a swirl gas flow. As discussed above and in the documents incorporated by reference, the microwave plasma can be generated by transmitting microwave power using a waveguide. In some embodiments, the plasma has a three dimensional shape that can vary over time during operation and depending upon certain input parameters, such as the angle of inclination of the swirl gas flow and the microwave power applied to the plasma. The plasma can also have a desired length, width, depth, shape, and periphery that all fall within acceptable ranges and that can also be adjusted or controlled in real time using the techniques disclosed herein.

At operation 505, the temperature profile of the microwave plasma is evaluated. At operation 507 it is determined whether the desired temperature profile of the plasma is achieved. If so, the method ends. If not, the method continues with adjusting in real time an injection angle of the swirl gas flow or the microwave power applied to the microwave plasma.

At operation 509, the swirl gas flow is adjusted. In some embodiments, adjusting the swirl gas flow includes adjusting the injection angle of the swirl gas by adjusting at least one movable gas jet nozzle. As discussed above, by adjusting the angle of inclination of the swirl gas flow using the movable gas jet nozzles the system can control in real time the temperature profile within the microwave plasma. In some embodiments, adjusting the injection angle of the swirl gas flow can be sufficient to achieve the desired temperature profile, and the method can end after operation 509. However, if additional adjustments to the temperature profile of the plasma, or any other parameter of the plasma, is needed, the method can continue with operation 511.

According to alternative embodiments, adjusting the swirl gas flow can include raising or reducing the magnitude of the swirl gas flow. In such embodiments, raising the magnitude of the swirl gas flow can increase mixing within the microwave plasma and homogenize the temperature profile within the microwave plasma. Reducing the magnitude of the swirl gas flow, however, can straighten the core gas flow.

At operation 511, the reflected microwave power applied to the microwave plasma is optimized using an adjustable waveguide tuner with a number of tuner positions, an adjustable waveguide sliding short, or both. One skilled in the art will appreciate that operation 511 can be performed before operation 509, or instead of operation 509 if adjusting the microwave power is sufficient to achieve the desired temperature profile of the plasma.

Once the swirl gas flow, the reflected microwave power, or both have been adjusted or optimized, the method can return to operation 505 and evaluate the temperature profile at the adjusted parameters. According to such a method, the microwave plasma can be adjusted in real time by controlling the input variables and recording the outputs of the plasma.

In the foregoing specification, the invention has been described with reference to specific embodiments thereof. However, various modifications and changes can be made thereto without departing from the broader spirit and scope of the invention. The specification and drawings are, accordingly, to be regarded in an illustrative rather than a restrictive sense.

What is claimed is:

1. A method of real time optimization of a microwave plasma, comprising:
adjusting in real time at least one of: an injection angle of a swirl gas flow of the microwave plasma, a magnitude of the swirl gas flow of the microwave plasma.

2. The method of claim 1, further comprising:
generating a microwave plasma utilizing a core gas flow and the swirl gas flow;
adjusting the injection angle of the swirl gas flow by adjusting at least one movable gas jet nozzle; and
optimizing a reflected microwave power measured from the microwave plasma using at least one of an adjustable waveguide tuner having a plurality of tuner positions, and an adjustable waveguide sliding short.

3. The method of claim 2, further comprising:
positioning a thermocouple at a location of interest with respect to the microwave plasma;
evaluating a temperature profile of the microwave plasma; and
adjusting the injection angle of the swirl gas by adjusting at least one movable gas jet nozzle in order to achieve a desired temperature profile in real time.

4. The method of claim 2, further comprising:
positioning a thermocouple at a location of interest with respect to the microwave plasma;
evaluating a temperature profile of the microwave plasma; and
optimizing reflected microwave power from the microwave plasma using at least one of an adjustable waveguide tuner having a plurality of tuner positions, and an adjustable waveguide sliding short to achieve a desired temperature profile in real time.

5. The method of claim 2, wherein the at least one movable gas jet nozzle includes a pivot joint protrusion extending from a portion of the at least one movable gas jet nozzle to secure the at least one movable gas jet nozzle within a bore of a cylindrical housing and allow the at least one movable gas jet nozzle to swivel within the bore at different angles.

6. The method of claim 2, wherein adjusting the at least one movable gas jet nozzle includes moving an adjusting ring that is in contact with the at least one movable gas jet nozzle to adjust an angle of orientation of the at least one movable gas jet nozzle.

7. The method of claim 2, further comprising:
raising a magnitude of the swirl gas flow to increase mixing within the microwave plasma and homogenize a temperature profile within the microwave plasma; or reducing a magnitude of the swirl gas flow to straighten the core gas flow.

8. A real time plasma optimization system comprising:
a plasma torch housing having at least one core gas flow port and at least one movable swirl gas flow port;
an adjustable waveguide tuner having a plurality of tuner positions; and
an adjustable waveguide sliding short.

9. The system of claim 8, wherein the adjustable waveguide tuner and the adjustable waveguide sliding short control in real time a reflected microwave power measured from a microwave plasma.

10. The system of claim 8, wherein the at least one movable swirl gas flow port adjusts the injection angle of a swirl gas.

11. The system of claim 8, wherein the at least one movable gas jet nozzle includes a pivot joint protrusion extending from a portion of the at least one movable gas jet nozzle to secure the at least one movable gas jet nozzle within a bore of the plasma torch housing and allow the at least one movable gas jet nozzle to swivel within the bore at different angles.

12. The system of claim 8, further comprising an adjusting ring in contact with the at least one movable gas jet nozzle to adjust an angle of orientation of the at least one movable gas jet nozzle.

13. The system of claim 8, wherein the plasma torch housing defines a plurality of bores disposed around an inlet of a plasma torch liner, and each of the plurality of bores includes one movable gas jet nozzle.

14. An adjustable gas inlet device, the gas inlet comprising:
a cylindrical housing having an outer surface and an inner surface, the outer surface having a greater circumference than the inner surface, the cylindrical housing defining at least one bore passing from the outer surface to the inner surface through the cylindrical housing;
at least one movable gas jet nozzle disposed within the at least one bore, wherein the at least one movable gas jet nozzle includes a gas inlet port proximal to the outer surface of the cylindrical housing and a gas outlet port proximal to the inner surface of the cylindrical housing and provides fluid communication from outside the outer surface to within the inner surface; and
a pivot joint protrusion extending from a portion of the at least one movable gas jet nozzle and in contact with the cylindrical housing within the at least one bore securing at least one movable gas jet nozzle within the at least one bore and allowing the at least one movable gas jet nozzle to swivel within the at least one bore at different angles.

15. The device of claim 14, wherein the cylindrical housing defines a plurality of bores disposed around the cylindrical housing.

16. The device of claim 15, wherein the cylindrical housing further defines an annular groove within the outer surface.

17. The device of claim 14, wherein the at least one bore passing from the outer surface to the inner surface through the cylindrical housing is oriented at an angle with respect to a radial line extending from a center of the cylindrical housing to the outer surface.

18. The device of claim 14, wherein the pivot joint protrusion has a rounded shape and fits within a socket within the at least one bore.

19. The device of claim 14, further comprising an adjusting ring in contact with the at least one movable gas jet nozzle to adjust an angle of orientation of the at least one movable gas jet nozzle.

20. The device of claim 14, wherein the cylindrical housing is positioned within a plasma torch housing and provides an angular gas flow through the at least one movable gas jet nozzle to a plasma chamber.
